(19) United States
(12) Patent Application Publication
(10) Pub. No.: US 2016/0147255 A1
(43) Pub. Date: May 26, 2016

(54) METHOD FOR AN ERGONOMICALLY CORRECT ADJUSTMENT OF A SCREEN, AND SET FOR CARRYING OUT SAME

(71) Applicant: Friedrich SCHERÜBEL, Graz (AT)

(72) Inventors: Friedrich SCHERUEBEL, Graz (AT); Manfred SLANA-JOEBSTL, Kainbach bei Graz (AT)

(73) Assignee: Friedrich SCHERUEBEL, Graz (AT)

(21) Appl. No.: 14/902,456

(22) PCT Filed: Jul. 4, 2014
(86) PCT No.: PCT/AT2014/050153

§ 371 Date: Jan. 27, 2016

(30) Foreign Application Priority Data
Jul. 4, 2013 (AT) A 50440/2013

(51) Int. Cl. G06F 1/16

(52) U.S. Cl. CPC G06F 1/1607

(57) ABSTRACT

The invention relates to a method for an ergonomically correct adjustment of a screen (2). The aim of the invention is to provide a simple adjustment with high precision. According to the invention, this is achieved in that an object (1) with which a user (9) sitting in front of the screen (2) is depicted on an image is removably arranged on a display region of the screen (2). A position of the screen (2) is then varied until a depiction of the user (9) is within specified borders of the image. The invention further relates to a set for such a method.

The invention relates to a method for an ergonomically correct adjustment of a screen.

The invention furthermore relates to a set for carrying out a method of this type.

Studies regularly show that visual display unit work leads to health problems which, among other reasons, are induced by an ergonomically suboptimal posture at workstations. This is often the result of an incorrectly adjusted screen. A screen is correctly adjusted when the screen is tilted in such a manner that a screen surface is perpendicular to a line of view of the viewer, wherein a viewing angle of the line of view centrally intersecting the screen surface is approximately 90°. Furthermore, it is ergonomically advantageous if a line of view is lowered 15° to 35° from a horizontal line.

An ergonomically preferable distance of a user from the screen is roughly equal to a length of an arm of the user. If the screen is not installed in an ergonomically correct manner, in particular, if it is positioned at an incorrect height and not tilted at a correct screen angle, the user unconsciously assumes a posture which corrects this incorrect positioning, which posture leads to an improper extension of the cervical vertebrae. An improper extension of the cervical vertebrae then results in compensatory and painful changes in the regions of the thoracic spine and lumbar spine. In addition, an incorrect sitting position with a “hunched back” causes lopsided pressure on spinal disks.

Because of increased sick leave and therapy costs, incorrectly adjusted screens result in a high economic loss. It has been shown that many users are not aware of a problem of an incorrectly adjusted screen and that there is also no easily and quickly applicable method for a correct positioning of the screen.

From the prior art, a reflective device has become known which is connected to the screen on a screen bezel in order to achieve an improved screen position during an adjustment of the screen by using a reflection of the user. In this method, it is disadvantageous that only the screen bezel can thereby be correctly adjusted and that a viewing angle to a center of the display region, at which a view of the user is directed, can be incorrectly aligned, as a consequence of which the health problems described above cannot be prevented.

The object of the invention is therefore to specify a method of the type named at the outset with which health problems caused by visual display unit work can be reduced. It should also be possible to implement the method in a particularly uncomplicated manner and to carry out the method with simple tools.

In addition, a set for carrying out a method of this type is to be specified which can be produced in a simple and cost-efficient manner.

The first object is attained by a method of the type named at the outset, wherein an object is removably arranged on a display region of the screen, with which object a user sitting in front of the screen is depicted on an image, whereupon a position of the screen is modified until a depiction of the user is within predefined borders of the image.

This enables a particularly simple positioning of the screen, wherein both an optimal viewing angle and also an optimal height of the screen are set using the simplest tools. In principle, any object can thereby be used with which an image of a user located in front of the screen can be produced and in particular also depicted, such as a device for image acquisition, image processing and image display. The arrangement of the predefined borders on the image is thereby particularly dependent on a position of the object arranged on the display region relative to a center of the display region. In this manner, a correct positioning can also already be present if the depiction of the user is only partially inside the image. By means of a preferably temporary positioning of the object in the display region, it is on the one hand ensured that the display region is correctly aligned. On the other hand, the object can be removed again following an adjustment and another screen can be adjusted using the method according to the invention, so that screens with different dimensions and designs can be adjusted with one object. Furthermore, it has been shown that with a method of this type and a simple conception of the object necessary therefor, ergonomic concepts can be made readily accessible to a user. As a result, a high learning effect and a positive effect for the health of the user can be achieved.

It is advantageous if a reflective object is used which preferably comprises a marking. The method is thus simplified, since any desired mirror can, for example, be connected to the screen, wherein an ergonomically correct position of the screen is present when the user looks into the mirror while maintaining an ergonomically correct sitting position. The image is thereby created and rendered by the reflective object. It has thereby proven effective if a reflective surface of the reflective object is arranged parallel to the display region on said region. Of course, the reflective surface can be embodied such that it is mirrored or holographic as desired, wherein mirrored materials with an interference effect as well as mirrored and simultaneously transparent materials can also be used. It is thus easily possible to set a viewing angle of 90°, since this viewing angle is achieved when a user looks at the center of a reflection on the reflective object. Markings can be provided on the mirror in order to identify an optimal position to which the screen must be adjusted accordingly with regard to the height and screen angle. In order to simplify a correct adjustment, these markings can have the shape of a face. The borders within which the depiction of the user is on the image when the screen is correctly positioned are thus defined in a simple manner.

The method can be implemented with low costs if an object embodied as an optical storage medium is used, in particular a CD, DVD or Blu-ray disc. In this manner, an accurate positioning is possible on the one hand because of a flat and reflective form of storage media of this type. On the other hand, instructions for carrying out the method or promotional messages can be contained on the storage medium in digital form, so that the user receives further added value. Preferably, what is referred to as a highly reflective DVD is used, which has a higher reflectance than conventional DVDs, in particular more than 90%, preferably more than 95%. As a result, the method can also be carried out in poor lighting conditions. However, a mirror made of plastic can also be used, for example, a mirror made of acrylic, of polystyrene or of polycarbonate.

A simple connection of the object to the screen is produced if the object is removably connected to an adapter that can be removably connected to the display region of the screen. In a simple embodiment, this can be a double-sided adhesive film, for example. However, an adapter can also be used that can be connected to the object in a positive fit and which is removably connected to the screen with a reversible adhesive technology or suction technology, in particular by means of adhesion. A connection between the object, adapter and screen can thereby be achieved in particular by a reversible adhesive technology, wherein a repeatedly adhering adhesive is used. Typically, an adhesive film or a cling film is used which is replaced by a new film when an adhesive force diminishes, for example due to frequent use. Normally, an adhesive layer for attaching the film to the object is embodied in such a manner that the layer can be removed from the object by hand without leaving behind adhesive residues on the object so that a new film can subsequently be applied. Alternatively, the object can be arranged directly on the screen.

To achieve a particularly preferable ergonomic position of the screen, it is advantageous if the object is arranged centrally in the display region. In this manner, a viewing angle of 90° to a center of the display region or to a center of the screen can be set in an extremely simple manner.

It is advantageous if the screen is positioned at a distance to the user that is equal to a length of an arm of the user. This allows a simple positioning of the screen at an optimal distance from the user. In a particularly simple manner, this can occur by an extension of an arm of the user all the way to the screen while the screen is adjusted. Alternatively, the corresponding length can be measured using known methods for determining distance and the screen can be adjusted by a comparison of a measured value thereby determined with a reference distance that results from an anatomy of the user.

To avoid an improper extension of the cervical vertebrae, it is also advantageous if an ergonomically beneficial deflection angle is adjusted by means of a level connected to the display region at a defined angle. The deflection angle thereby refers to the angle by which a line of view of the viewer must be lowered from a horizontal line in order to intersect the display region perpendicularly. A deflection angle of 15° to 35° is ergonomically advantageous. The deflection angle thus also corresponds to an angle by which the display region is tilted relative to a vertical line. In principle, any desired device for measuring an absolute angle, which device renders possible a setting of a defined deflection angle, can be connected to the display region, such as a plumb line provided with an angle scale, an accelerometer or the like. It has proven particularly simple from a design standpoint if a slightly curved plastic or glass tube filled with a liquid and an air or gas bubble, also referred to as a level, is used. For this purpose, the level is preferably removably connected to the display region at an angle complementary to the deflection angle, so that a correct adjustment of the display region relative to a vertical line can be easily determined based on a position of the air bubble in the level. Preferably, the level is thereby attached to a level adapter that can advantageously be removably connected to the display region by a cling film, such as a Gecko film, and which normally has a first leg and a second leg. The two legs are thereby typically connected in a fixed manner at an angle complementary to the deflection angle, wherein the Gecko film is normally arranged on the rear side of the first leg. The level is attached to the second leg such that the level is in a virtually horizontal position when the level adapter is arranged on the display region if the display region is deflected from the vertical line by the defined deflection angle. Alternatively, the legs can also be rotatably connected about a rotation axis, so that different deflection angles can be set using the level adapter. Of course, the level can also be connected to the screen in any other suitable manner, for example, by a suction pad or by means of a reversible adhesive technology.

Where a suction pad is used to attach the adapter, the object or the level, it has proven advantageous that the suction pad is integrated in a rear recess of the adapter, object or level and that it can be actuated from a front side via a through hole.

For a simple design, the level adapter can thereby be integrated into the adapter for accommodating the object.

Alternatively, the level adapter can be embodied as a separate component that is connected to the display region separately from the adapter. In this manner, particularly small components can be achieved which can be easily stored and shipped.

It is advantageous if the level adapter is composed of the same material as the adapter. In particular, polymethyl methacrylate or acrylic glass has proven visually and haptically attractive. Of course, the level adapter can also be composed of other materials, for example polystyrene or polycarbonate.

It can also be provided that, independent of an adjustment of a viewing angle, a device for measuring an absolute angle is removably attached to the screen, by means of which device the deflection angle is adjusted. For example, this can be a level with a level adapter or an electronic sensor such as an accelerometer. If a screen is used which comprises an integrated camera, the viewing angle can then be adjusted in an ergonomically correct manner using, for example, a depiction on the screen of an image acquired by the camera. The deflection angle, which cannot be adjusted due to the camera being integrated into the screen, is then adjusted in a simple manner by the device for measuring an absolute angle, which device is preferably removably arranged on the screen.

The other object is attained by a set of the type named at the outset which comprises an object with which a part of a surrounding region of the object can be depicted on an image and a means of attachment with which the object can be removably attached to a display region of the screen. A set of this type makes it possible to carry out a method according to the invention using the simplest of means.

It is preferably provided that the object is an optical storage medium, in particular a CD, DVD or Blu-ray disc. Since objects of this type are affordably produced by virtue of large quantities, the costs necessary for carrying out the method are minimized.

A simple and releasable bonding of the object can be achieved on the display region if the means of attachment comprises a cling film and is in particular removably connected to the object. This can be achieved, for example, by an adapter that is connected to the object in a positive fit and which comprises on one side a cling film that can be removably connected to the display region. Films of this type are also referred to as Gecko films and can be used multiple times to produce a removable connection. Alternatively, a design of the adapter with a suction pad for attaching the object to the display region is also possible.

To properly adjust a deflection angle using the set, it is advantageous if the set comprises a level adapter with which a defined absolute monitor tilt angle can be adjusted, wherein in particular a level is connected to the level adapter in a fixed manner.

Alternatively, the set can also be composed solely of a device for measuring an absolute angle, which device can be removably connected to the screen. It is thus possible, for example, to easily adjust a screen with an integrated camera, such as the screen of a laptop, in an ergonomically correct manner if the viewing angle is adjusted by means of a rendering of the image acquired by the camera integrated in the screen and if the deflection angle is adjusted by means of the device for measuring an absolute angle.

Additional features, benefits and effects of the invention follow from the exemplary embodiment described below. The drawings which are thereby referenced show the following:

FIG. 1 shows a screen with an object for carrying out the method according to the invention;

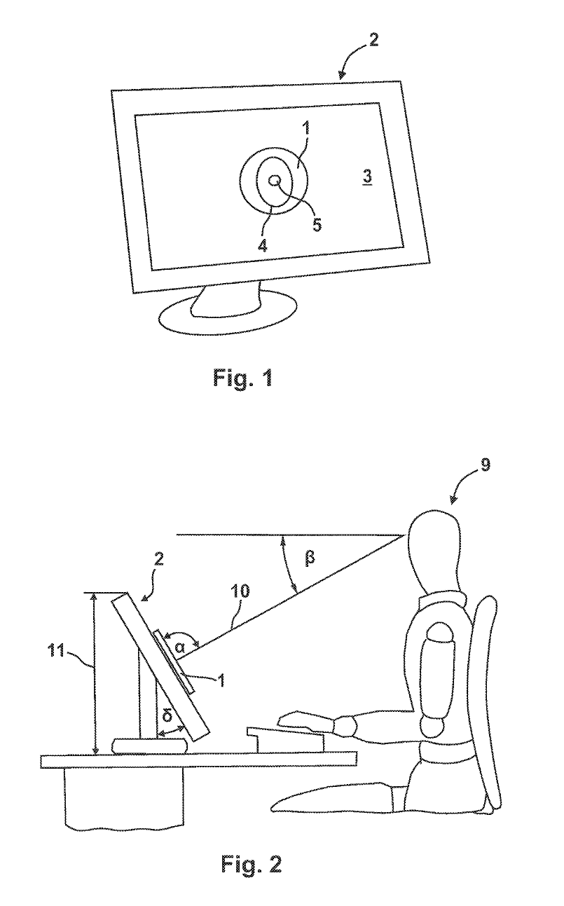

FIG. 2 shows a schematic illustration of a visual display unit workstation;

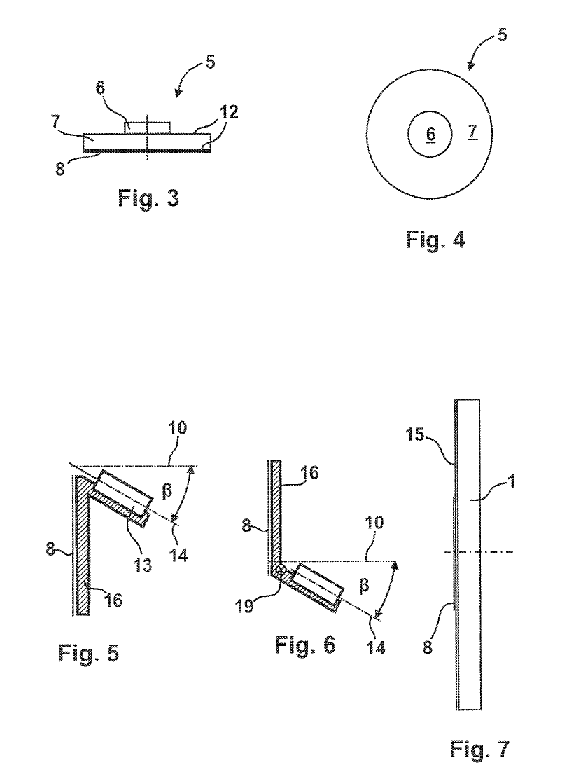

FIGS. 3 and 4 show an adapter for a set according to the invention;

FIGS. 5 and 6 show different embodiments of a level adapter with a level;

FIGS. 7 through 11 show different embodiments of a set according to the invention;

FIG. 12 shows a level for a set according to the invention in a top view;

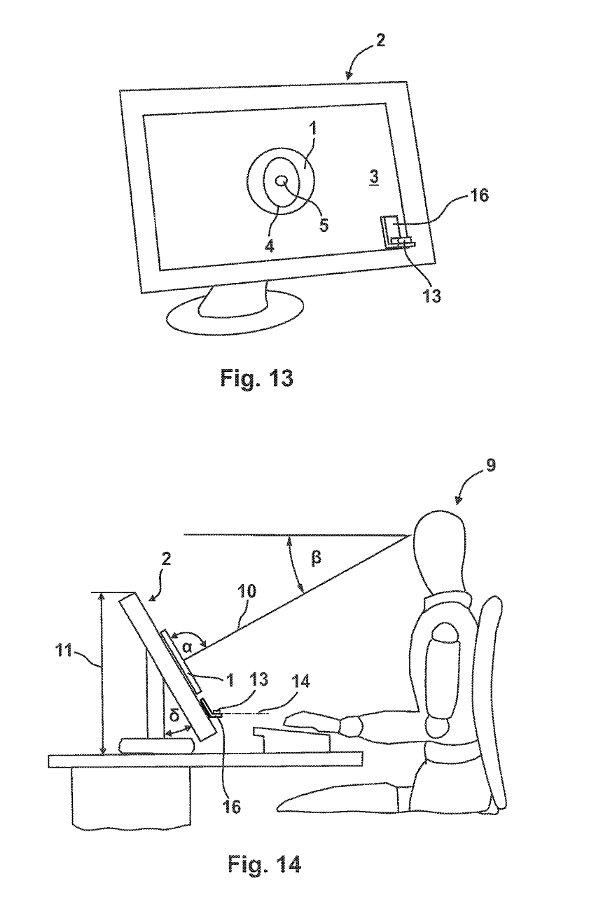

FIG. 13 shows a screen with an object and a level adapter for carrying out the method according to the invention;

FIG. 14 shows a further schematic illustration of a visual display unit workstation;

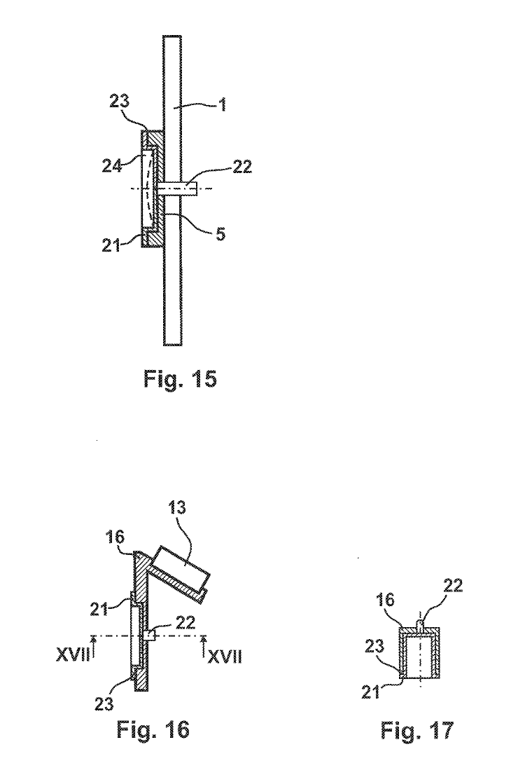

FIG. 15 shows a section through an additional adapter with an object for carrying out the method according to the invention;

FIGS. 16 and 17 show a further embodiment of a level adapter and level for a set according to the invention in different cross-sectional views.

FIGS. 1 and 2 show a screen 2, wherein an object 1 embodied as a DVD is removably attached to the center of a display region 3 of the screen 2. The DVD is thereby connected to the display region 3 by an adapter 5 that is removably connected to the DVD at a central insertion opening. In this embodiment, the set according to the invention is composed of a DVD and the adapter 5, which can be removably connected to the display region 3 of the screen 2 and the DVD. An ergonomically correct adjustment of the screen 2 for a user 9 located in front of the screen 2 is performed by modifying a height 11 and a screen angle δ of the screen 2 until a reflection of the user 9 appears within a marking 4 affixed to the DVD, as viewed from a position of the user 9.

FIG. 2 shows, in an enhanced view, a visual display unit workstation with a user 9. It can be seen that the object 1 embodied as a DVD is arranged on the screen 2 in the display region 3 of the screen 2, wherein a reflective surface of the DVD is preferably positioned parallel to a plane of the display region 3. When the method is carried out, the height 11 and screen angle δ of the screen 2 are modified relative to the user 9 until the user 9 sees himself/herself in the DVD. This occurs precisely when a viewing angle α between a line of view 10 of the user 9 and a plane on which the display region 3 lies is equal to approximately 90°. By means of the central arrangement of the DVD on the display region 3, a correct viewing angle α to a center of the display region 3 or to a middle of the screen is ensured. Since a correct distance between the user 9 and screen 2 is equal to a length of an arm of the user 9, an optimal distance between the screen 2 and the user 9 can be adjusted in a particularly simple manner if the screen 2 is adjusted by the user 9 with extended arms from the a seated position of the user 9. Furthermore, it is advantageous for an ergonomically correct screen position if a deflection angle β, by which the line of view 10 is lowered from a horizontal line, is equal to 15° to 35°. This correct deflection angle β can be easily attained by the user 9 in the method according to the invention in that the screen 2 is adjusted until the user 9 sees himself/herself in a reflection on the DVD and his/her head is thereby tilted slightly downwards. After the method according to the invention is carried out, the DVD is removed from the display region 3 and can be used to adjust another screen 2.

FIGS. 3 and 4 show, in detail, an adapter 5 according to FIG. 1 for a set according to the invention. The adapter 5 illustrated is designed for an object 1 embodied as a CD, DVD or Blu-ray disc and comprises a top part 6 which can be removably connected to a central circular insertion opening of a CD, DVD or Blu-ray disc, for example, by a fitting of the top part 6 into the insertion opening. Furthermore, a preferably cylindrically embodied bottom part 7 is provided which comprises parallel surfaces 12 for positioning the CD, DVD or Blu-ray disc parallel to the display region 3 on the same. To removably connect the adapter 5 to the display region 3 of a screen 2, an adhesive film arranged on the bottom part 7 is provided. A wide range of different adhesive films can be used, for example. A particularly residue-free bond of the adapter 5 to the display region 3 is possible if a cling film 8 is used, as in the exemplary embodiment illustrated, which film is also referred to as a Gecko film.

The method according to the invention enables a simple and quick ergonomically correct adjustment of a screen 2 so that damage resulting from an incorrect screen positioning can be easily avoided. Furthermore, a set for the method according to the invention can be affordably produced, for which reason the costs for carrying out the method are also minimal.

FIGS. 5 and 6 show embodiments of a level adapter 16 that is preferably made of plastic or acrylic glass and with which a screen tilt angle can be adjusted. An ergonomically correct screen tilt angle results in a deflection angle β of 15° to 35° so that the display region 3 is positioned at this angle to a vertical line. The level adapter 16 comprises two legs, wherein on a first leg, a cling film 8 such as a Gecko film is typically provided, by means of which the level adapter 16 can be removably connected to the viewing region 3 of the screen 2. On a second leg of the level adapter 16, a level 13 is arranged, wherein a level axis 14 is arranged at an angle to the first leg that is complementary to the deflection angle β, so that the line of view 10 is positioned at the deflection angle β to the level axis 14 when the screen 2 is aligned correctly. The level 13 can be embodied as a circular level or a tubular level so as to allow a measurement of a deflection from the horizontal in one or two directions. For a simple design, a use of a tubular level has proven expedient. The level 13 can be an integral component of the level adapter 16, for example, if the level adapter 16 is designed as a cast part. Alternatively, the level 13 can also be embodied as an additional component that is connected to a level adapter 16. A connection can thereby be produced, for example, by means of a positive fit, an adhesive connection or a welded connection. For high visibility in poor lighting conditions, the level 13 can comprise fluorescent or illuminated elements.

In FIG. 6, an alternative embodiment is shown, wherein the first leg and the second leg are not connected in a fixed manner, but rather rotatably about a rotation axis 19 in order to enable the simple use of the level adapter 16 for different deflection angles β. For this purpose, a scale or grid can be provided on the level adapter 16 for setting any desired deflection angle β. Whether a level adapter 16 according to FIG. 6, in which the first leg is arranged above the second leg, or a level adapter 16 according to FIG. 5 is used can be made to depend on a visual impression at the workstation.

FIG. 7 shows an embodiment of an object 1 for carrying out the method according to the invention, which object is not designed as an optical storage medium. An object 1 according to FIG. 7, which can also be designed as a plastic mirror, comprises a transparent plastic body, in particular composed of polymethyl methacrylate or acrylic glass. On a rear side, a reflective layer 15 is provided with which the image of the user 9 can be displayed as a reflection. To attach the object 1 to the display region 3, a cling film 8 is provided on the reflecting layer 15 arranged on the rear side.

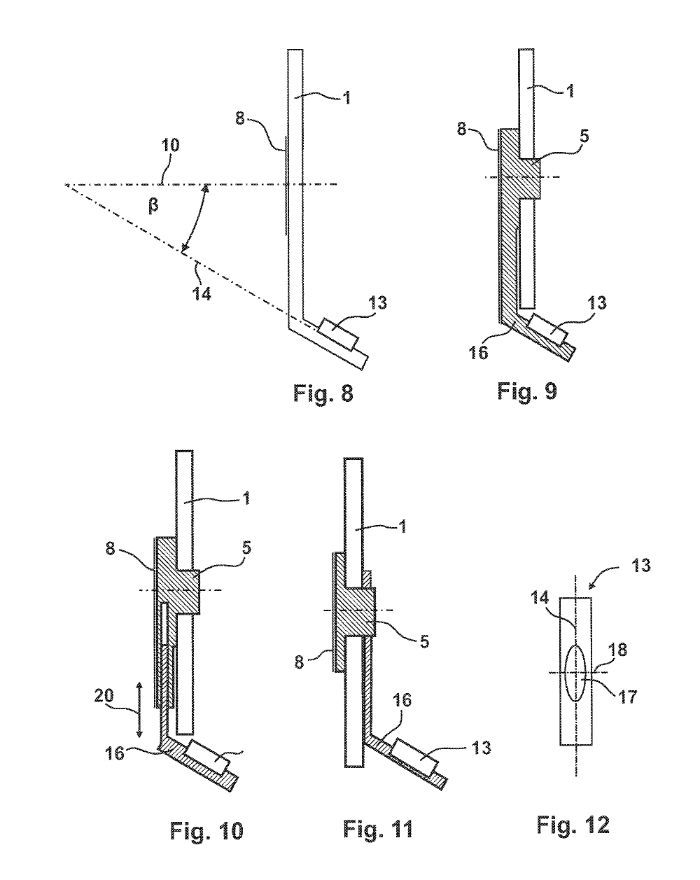

FIG. 8 shows an object 1 according to FIG. 7, wherein a level adapter 16 comprising a level 13 is connected integrally to the object 1. The level axis 14 is thereby positioned at a deflection angle β to a line of vision 10 that is perpendicular to the object 1.

FIGS. 9 through 11 each show a set according to the invention, with which set both a correct viewing angle α and also a correct deflection angle β can be adjusted, wherein the object 1 is normally embodied as a DVD and removably attached to an adapter 5. In the embodiment according to FIG. 9, a level adapter 16 is connected integrally to the adapter 5. In the embodiment according to FIG. 10, the level adapter 16 is movably connected to the adapter 5 along a displacement direction 20 to allow a suitable adaptation of the set. FIG. 11 shows an embodiment, wherein the level adapter 16, like the DVD, is removably connected to the adapter 5 by means of a positive fit.

A level 13 embodied as a tubular level is schematically illustrated in FIG. 12. When the level 13 is arranged on the screen 2 as described above by means of a level adapter 16, an air bubble 17 is positioned within a marked region at a level center 18 when the screen tilt angle is correct. An incorrect screen tilt angle causes the air bubble 17 to be moved out of the marked defined region at the level center 18, whereby a simple adjustability of the screen tilt angle is ensured.

FIG. 13 shows a screen 2 on which on the one hand an object 1 with a marking 4 is arranged by means of an adapter 5 in order to adjust the viewing angle α and, on the other hand, a level adapter 16 according to FIG. 6 with a level 13 is arranged for a correct adjustment of the deflection angle β. The level adapter 16 is thereby removably attached to the display region 3 of the screen 2 separately from the adapter 5 by means of a Gecko film.

FIG. 14 schematically illustrates a visual display unit workstation with a screen 2 on which the object 1 and the level adapter 16 and level 13 are arranged for the method according to the invention. To carry out the method, a correct screen angle δ or a deflection angle β is typically adjusted in a first step by means of the level adapter 16 and level 13, wherein the screen angle δ is modified until the level 13 is in a horizontal position. This is easily recognizable for the user 9 with the aid of the air bubble 17 located in the marked region at the level center 18. In a second step, the height 11 of the screen 2 is then modified until the user 9 sees himself/herself at the center of a reflection on the object 1. Thus, an ergonomically correct adjustment of the screen 2 can be performed in a simple manner.

FIG. 15 shows an object 1 that can be attached to a screen 2 by an adapter 5 in order to carry out the method according to the invention. The adapter 5 can thereby be removably connected to a display region 3 of a screen 2 by means of a suction pad 21. As is shown, the suction pad 21 is arranged in a rear recess of the adapter 5, so that a simple parallel positioning of the normally reflective object 1 is possible relative to the display region 3 of the screen 2. The suction pad 21 is connected to the adapter 5 by a bond 23 in an edge region. A central region of the suction pad 21 can be moved relative to the adapter 5 so that a hollow space 24 with a modifiable volume is formed between the suction pad 21, which is normally composed of rubber or the like, and a screen 2. A volume of the hollow space 24 can be changed by pressing the actuating button 22 to produce a negative pressure in the hollow space 24 for attaching the adapter 5 to the screen 2 by means of the suction pad 21. The actuating button 22 is also pressed to remove the adapter 5 from the screen 2, whereby a central region of the suction pad 21 is brought into a position indicated by a dashed line, so that a negative pressure is no longer present in the hollow space 24.

FIGS. 16 and 17 show sections through a further embodiment of a level adapter 16 and level 13. FIG. 17 thereby shows a section through a level adapter 16 along the line XVII-XVII in FIG. 16. As can be seen, the level adapter 16 is can be attached to a screen 2 by means of a suction pad 21 arranged in a rear recess. The suction pad 21 is thereby connected to the level adapter 16 at an edge by a bond 23. In this embodiment, a size of a hollow space 24 between the suction pad 21 and screen 2 can, similar to the suction pad 21 illustrated in FIG. 15, also be modified by pressing an actuating button 22 from a front of the level adapter 16, since the actuating button 22 protrudes through the level adapter 16. The level 13 or the level adapter 16 can thus repeatedly be removably connected to a display region 3 of a screen 2 in a simple manner in order to align the screen in an ergonomically correct manner.

1. Method for an ergonomically correct adjustment of a screen (2), characterized in that an object (1) is removably arranged on a display region (3) of the screen (2), with which object a user (9) sitting in front of the screen (2) is depicted on an image, whereupon a position of the screen (2) is modified until a depiction of the user (9) is within predefined borders of the image.

2. Method according to claim 1, characterized in that a reflective object (1) is used which preferably comprises a marking (4).

3. Method according to claim 1, characterized in that an object (1) embodied as an optical storage medium is used, in particular a CD, DVD or Blu-ray disc.

4. Method according to claim 1, characterized in that the object (1) is removably connected to an adapter (5) that can be removably connected to the display region (3) of the screen (2).

5. Method according to claim 1, characterized in that the object (1) is centrally arranged in the display region (3).

6. Method according to claim 1, characterized in that an ergonomically advantageous deflection angle (β) is adjusted by means of a level (13) connected to the display region (3) at a defined angle.

7. Set for carrying out a method according to claim 1, characterized in that the set comprises an object (1) with which a part of a surrounding region of the object (1) can be depicted on an image and a means of attachment with which the object (1) can be removably attached to a display region (3) of a screen (2).

8. Set according to claim 7, characterized in that the object (1) is an optical storage medium, in particular a CD, DVD or Blu-ray disc.

9. Set according to claim 7, characterized in that the means of attachment comprises a cling film (8) and, in particular, is removably connected to the object (1).

10. Set according to claim 7, characterized in that the set comprises a level adapter (16) with which a defined absolute screen tilt angle can be adjusted, wherein in particular a level (13) is connected to the level adapter (16) in a fixed manner.
